(19) United States
(12) Patent Application Publication
(10) Pub. No.: US 2021/0108923 A1
(43) Pub. Date: Apr. 15, 2021

(54) INFORMATION PROCESSING APPARATUS, INFORMATION PROCESSING METHOD, AND PROGRAM

(71) Applicant: SONY CORPORATION, Tokyo (JP)

(72) Inventor: Masato KIMISHIMA, Tokyo (JP)

(73) Assignee: SONY CORPORATION, Tokyo (JP)

(21) Appl. No.: 17/046,345

(22) PCT Filed: Feb. 19, 2019
(86) PCT No.: PCT/JP2019/006016

§ 371 Date: Oct. 9, 2020

(30) Foreign Application Priority Data
May 9, 2018 (JP) 2018-090916

(51) Int. Cl. G01C 21/16; H04W 4/02; H04W 4/029

(52) U.S. Cl. CPC G01C 21/16; H04W 4/029; H04W 4/027

(57) ABSTRACT

There is provided an information processing apparatus that allows for autonomous improvement of position estimation accuracy. The information processing apparatus includes: an inertial navigation computing unit that calculates, on a basis of a measurement value relating to a moving body measured by an inertial measurement unit, a status value relating to a moving status of the moving body by an inertial navigation system; an observation value computing unit that calculates an observation value relating to the moving status of the moving body on a basis of a characteristic amount of movement relating to a movement of the moving body, the characteristic amount of movement being calculated on a basis of the measurement value; and an attitude information computing unit that calculates attitude information relating to an attitude of the moving body on a basis of the status value and the observation value.

### TECHNICAL FIELD

The present disclosure relates to an information processing apparatus, an information processing method, and a program.

### BACKGROUND ART

Today, mobile terminals such as smartphones incorporate widely spread techniques for estimating positions on the basis of information measured by a built-in inertial sensor and the like. One method of position estimation, for example, uses an autonomous positioning method such as pedestrian dead reckoning (PDR: Pedestrian Dead Reckoning). However, with the autonomous positioning method, errors involved in movement accumulate in an estimation result, which lowers accuracy of position estimation is lowered. Accordingly, techniques for improving the accuracy of position estimation are also proposed, in which the estimation result with cumulative errors is corrected.

For example, Patent Literature 1 below discloses a technique by which a mobile terminal corrects a position and an orientation of the mobile terminal estimated by itself using an autonomous positioning method on the basis of information received from an external device. Specifically, the mobile terminal estimates the position and the orientation of the mobile terminal on the basis of information measured by a built-in accelerometer and gyro sensor. The mobile terminal then corrects the estimated position and orientation on the basis of position information of a transmitter received from the transmitter, which is an external device.

### CITATION LIST

### Patent Literature

PTL 1: Japanese Unexamined Patent Application Publication No. 2015-135249

### SUMMARY OF THE INVENTION

### Problems to be Solved by the Invention

However, the technique described above presupposes that the mobile terminal receives the information necessary for the correction of the estimated position and direction from an external device. Therefore, in a case where the reception environment is poor when receiving information from the external device, the mobile terminal may sometimes fail to receive the information necessary for the correction of the position and direction and is not able to correct the position and direction. In this case, errors remain accumulated in the position and direction estimated by the mobile terminal, and the estimation accuracy of the position and direction are not improved.

Accordingly, the present disclosure proposes an information processing apparatus, an information processing method, and a program that are novel and improved and allow for autonomous improvement of position estimation accuracy.

### Means for Solving the Problems

According to the present disclosure, there is provided an information processing apparatus including: an inertial navigation computing unit that calculates, on a basis of a measurement value relating to a moving body measured by an inertial measurement unit, a status value relating to a moving status of the moving body by an inertial navigation system; an observation value computing unit that calculates an observation value relating to the moving status of the moving body on a basis of a characteristic amount of movement relating to a movement of the moving body, the characteristic amount of movement being calculated on a basis of the measurement value; and an attitude information computing unit that calculates attitude information relating to an attitude of the moving body on a basis of the status value and the observation value.

Further, according to the present disclosure, there is provided an information processing method executed by a processor, the information processing method including: calculating, on a basis of a measurement value relating to a moving body measured by an inertial measurement unit, a status value indicating a moving status of the moving body by an inertial navigation system; calculating an observation value that is a correct value on a basis of a characteristic amount of movement relating to a movement of the moving body, the characteristic amount of movement being calculated on a basis of the measurement value; and calculating attitude information relating to a correct attitude of the moving body on a basis of the status value and the observation value.

Further, according to the present disclosure, there is provided a program that causes a computer to function as: an inertial navigation computing unit that calculates, on a basis of a measurement value relating to a moving body measured by an inertial measurement unit, a status value indicating a moving status of the moving body by an inertial navigation system; an observation value computing unit that calculates an observation value that is a correct value on a basis of a characteristic amount of movement relating to a movement of the moving body, the characteristic amount of movement being calculated on a basis of the measurement value; and an attitude information computing unit that calculates attitude information relating to a correct attitude of the moving body on a basis of the status value and the observation value.

### Effects of the Invention

As described above, the present disclosure allows for autonomous improvement of position estimation accuracy.

It should be noted that the above-described effect is not necessarily limiting. Any of the effects indicated in this description or other effects that can be understood from this description may be exerted in addition to the above-described effect or in place of the above-described effect.

### BRIEF DESCRIPTION OF DRAWINGS

FIG. 1 is an explanatory diagram illustrating an overview of a common inertial navigation system.

FIG. 2 is an explanatory diagram illustrating an example of an error in the common inertial navigation system.

FIG. 3 is an explanatory diagram illustrating an overview of a common pedestrian dead reckoning method.

FIG. 4 is an explanatory diagram illustrating an overview of an embodiment of the present disclosure.

FIG. 5 is an explanatory diagram illustrating an example of correction of a moving speed according to the embodiment.

FIG. 6 is a block diagram illustrating an example of a functional configuration of a mobile terminal according to the embodiment.

FIG. 7 is an explanatory diagram illustrating an example of application of a Kalman filter according to the embodiment.

FIG. 8 is a flowchart illustrating an example of operation of the mobile terminal when the Kalman filter is applied according to the embodiment.

FIG. 9 is an explanatory diagram illustrating an example of correction of an attitude of a moving body according to the embodiment.

FIG. 10 is an explanatory diagram illustrating an example of correction of a position of a moving body according to the embodiment.

FIG. 11 is an explanatory diagram illustrating an example of application of a constraint according to the embodiment.

FIG. 12 is a flowchart illustrating an example of operation of the mobile terminal when the constraint is applied according to the embodiment.

FIG. 13 is a flowchart illustrating an example of a process of searching for an optimal attitude error when the constraint is applied according to the embodiment.

FIG. 14 is a block diagram illustrating an example of a hardware configuration of the mobile terminal according to the embodiment.

### MODES FOR CARRYING OUT THE INVENTION

The following describes a preferred embodiment of the present disclosure in detail with reference to the accompanying drawings. Note, constituent elements having substantially the same functional configuration are given the same reference signs in this description and the drawings and redundant description thereof is thus omitted.

The description will be given in the following order.

### 1. Embodiment of Present Disclosure

1.1. Overview

1.2. Functional Configuration Example

1.3. Operation Example

1.4. Test Examples

### 2. Modification Examples

### 3. Hardware Configuration Example

### 4. Conclusion

### 1. EMBODIMENT OF PRESENT DISCLOSURE

### 1.1. Overview

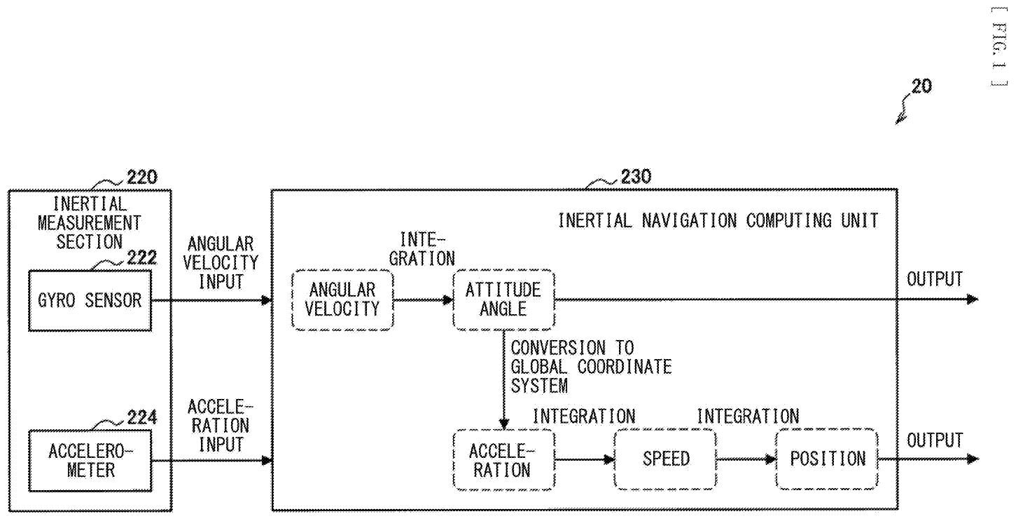

Below, an overview of an embodiment of the present disclosure will be described with reference to FIG. 1 to FIG. 5. Note, in the following, an object whose position is to be estimated is also referred to as moving body. Examples of the moving body may include, for example, a mobile terminal such as a smartphone, a tablet terminal, or a wearable terminal having a position estimation function installed therein. Also, in a case where a human carries the mobile terminal, both the mobile terminal and the human are included in the concept of moving body. The same applies to cases where the mobile terminal is carried by an animal other than the human, a robot, and the like, as well as to a case where a terminal having a position estimation function is installed in a car. Note, the examples of the moving body are not limited to the examples given above.

Currently, some of mobile terminals such as smartphones are each equipped with a function of estimating a position of the mobile terminal on the basis of information measured by a built-in inertial measurement unit (IMU: Inertial Measurement Unit) or the like. One position estimation method involving estimating a position of a moving body by an inertial navigation system (INS: Inertial Navigation System), for example, which calculates an attitude, a moving speed, and a position of the moving body through integration of values measured by the IMU. Another position estimation method involves estimating a position of a moving body by pedestrian dead reckoning (PDR: Pedestrian Dead Reckoning), which calculates the position of the moving body on the basis of values measured by the IMU and characteristic amounts relating to the movement of the moving body.

(1) Position Estimation by Inertial Navigation System

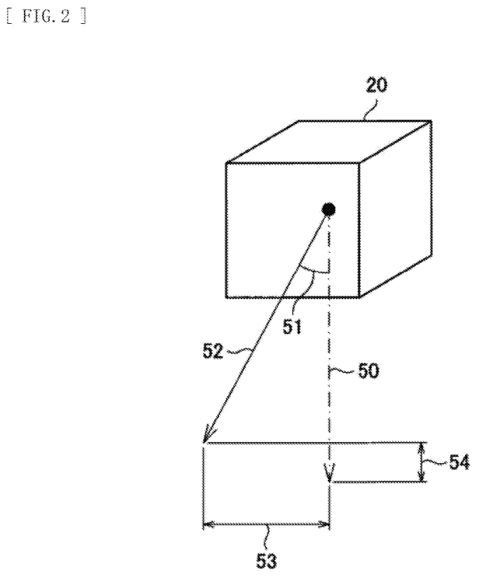

Now, a common inertial navigation system will be described with reference to FIG. 1 to FIG. 2. FIG. 1 is an explanatory diagram illustrating an overview of a common inertial navigation system. FIG. 2 is an explanatory diagram illustrating an example of an error in the common inertial navigation system.

FIG. 1 illustrates a functional configuration example of a mobile terminal 20 that carries out position estimation of the terminal by an inertial navigation system. It is assumed that the mobile terminal 20 includes an inertial measurement section 220 that measures inertial data (measurement values) of the mobile terminal 20, and an inertial navigation computing unit 230 that performs inertial navigation. Moreover, it is assumed that the inertial measurement section 220 includes a gyro sensor 222 and an accelerometer 224 as IMUs. The inertial navigation computing unit 230 in the mobile terminal 20 performs a process of estimating the position of the mobile terminal 20 by an inertial navigation system on the basis of the inertial data of the mobile terminal 20 measured by the inertial measurement section 220.

Specifically, the inertial measurement section 220 inputs an angular velocity measured by the gyro sensor 222 and an acceleration measured by the accelerometer 224 to the inertial navigation computing unit 230. The inertial navigation computing unit 230 calculates an attitude angle that is an angle indicative of the attitude of the mobile terminal 20 by integrating the inputted angular velocity, and outputs the attitude angle. Also, the inertial navigation computing unit 230 converts the coordinate system of the inputted accelerations from a terminal coordinate system into a global coordinate system on the basis of the calculated attitude angle. After converting the coordinates of the acceleration, the inertial navigation computing unit 230 calculates a speed by integrating the coordinate-converted accelerations, calculates the position by integrating the speed, and outputs the position.

As described above, the inertial navigation system is able to calculate the moving speed vector of the moving body by integration of inertial data. The inertial navigation system is also able to calculate the speed and the position of the moving body in any motion condition. For example, suppose a user carrying the mobile terminal 20 is walking. At this time, even when the user turns and changes the orientation of the mobile terminal 20 while walking, the inertial navigation computing unit 230 of the mobile terminal 20 is still able to calculate the speed and the position of the mobile terminal 20. This is why the inertial navigation is a method that has long been used for obtaining the speed and the position of an aircraft, a ship, a spacecraft, and so on while moving. The inertial navigation system is also used in cases where errors are to be corrected highly precisely in position estimation.

However, in a case where integrated inertial data contains errors, these errors are cumulated by integration, because the inertial navigation system calculates the speed and the position of the moving body by integration. Also, an error divergence rate is increased. For example, suppose there occurs an attitude error in a rotating direction around a roll axis or a pitch axis of the moving body as the rotation axis due to errors contained in the initial attitude of the moving body estimated in the initial state, or due to biases or the like of the gyro sensor. Portion of the gravity being counted as a kinetic acceleration at this time due to the attitude error (hereinafter also referred to as gravity cancel error) causes an error in the inertial data, resulting in increased rate of divergence of integration errors.

Specifically, suppose the attitude of the mobile terminal 20 is free of errors and the mobile terminal 20 is being subjected to a gravitational force 50, which is a true value, as illustrated in FIG. 2. However, in a case where the estimated attitude contains an error of an angle 51 due to an initial attitude error or an influence of a bias, it is estimated that the mobile terminal 20 in the attitude including the error is subjected to gravity or a gravitational force 52 that is an estimated value. The magnitudes of the gravitational force 50 that is a true value and the gravitational force 52 that is an estimated value represent the magnitudes of kinetic accelerations created by respective gravities. Therefore, the measured inertial data inevitably contains differences between the gravitational force 52 that is an estimated value and the gravitational force 50 that is a true value, i.e., a horizontal gravity cancel error 53 and a vertical gravity cancel error 54.

When measured inertial data contains errors, these errors are accumulated and the divergence rate increases, because inertial navigation uses integration as described above. On the other hand, the pedestrian dead reckoning does not use integration, so that the estimated position of the moving body does not contain integration errors such as those in inertial navigation.

### (2) Position Estimation by Pedestrian Dead Reckoning

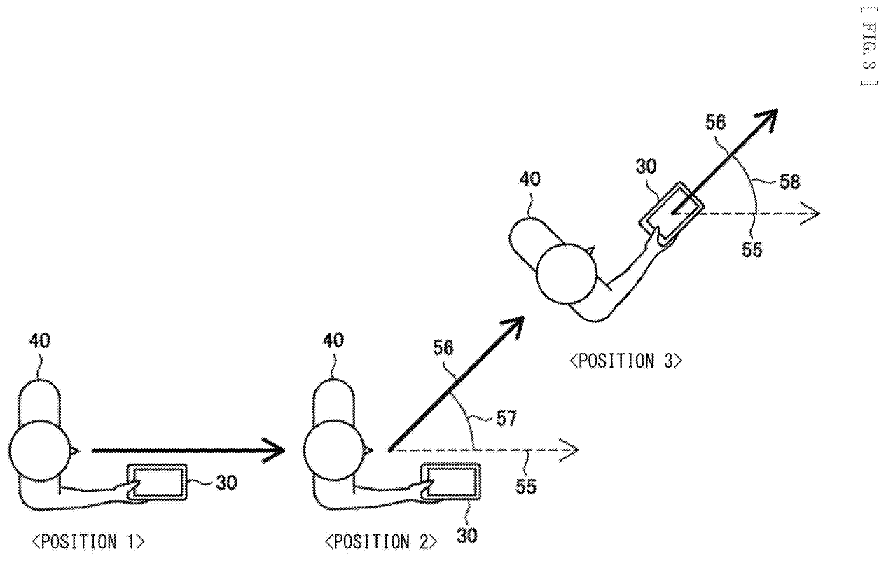

Now, a common pedestrian dead reckoning method will be described with reference to FIG. 3. FIG. 3 is an explanatory diagram illustrating an overview of a common pedestrian dead reckoning method.

FIG. 3 illustrates a mobile terminal 30 that estimates a position of the terminal by pedestrian dead reckoning and a user 40 carrying the mobile terminal 30. The pedestrian dead reckoning performs relative positioning that estimates a current position of the user 40 by calculating a moving distance from a point where positioning has been started and an amount of change in azimuth angle, on the basis of inertial data measured by an IMU and a characteristic amount related to the movement of the user 40. For example, the moving distance from the point where positioning has been started is calculated on the basis of the walking speed of the user 40, and the amount of change in azimuth angle is calculated on the basis of the angular velocity measured by a gyro sensor. The walking speed of the user 40 is calculated by multiplying a stride frequency by a stride length of the user 40. Note, the stride frequency of the user 40 represents+the number of steps per unit time. The stride frequency may be calculated on the basis of an acceleration measured by an accelerometer. The stride length of the user 40 may be a preset value, or may be calculated on the basis of the information received from a global navigation satellite system (GNSS: Global Navigation Satellite System).

It should be noted that pedestrian dead reckoning is subject to a precondition that the orientation of the mobile terminal 30 as it rotates around the yaw axis as the rotation axis coincides with the moving direction of the user 40, and that the orientation of the mobile terminal 30 is set to be the moving direction of the user 40 at the start of positioning. For example, in a case where location positioning of the user 40 carrying the mobile terminal 30 is started at a position 1 indicated in FIG. 3, the orientation of the mobile terminal 30 at the position 1 is set as the moving direction of the user 40. Here, an axis along a short-side direction of the mobile terminal 10 is a pitch axis, an axis perpendicular to a long-side direction and the pitch axis of the mobile terminal 10 is a roll axis, and an axis perpendicular to the pitch axis and the roll axis is a yaw axis. Here, the yaw axis shall be set to coincide with the direction of gravity applied to the mobile terminal 10. Note, the pitch axis, roll axis, and yaw axis are not limited to these examples and may be set as suited. Here, the orientation of the mobile terminal 30 represents a direction of an upper part of a display screen of the mobile terminal 30 as held by the user 40 such that the screen of the mobile terminal 30 is horizontal to the ground surface, and that the long-side direction of the mobile terminal 30 is parallel to the moving direction of the user 40.

Therefore, when a discrepancy occurs between the moving direction of the user 40 and the orientation of the mobile terminal 30 after the start of positioning, an error is created in the moving direction to be estimated in accordance with the discrepancy. For example, when the user 40 moves from the position 1 to a position 2 indicated in FIG. 3, there is no change in the orientations of the user 40 and the mobile terminal 30. Accordingly, no error occurs in the estimated moving direction of the user 40. Also, when the user 40 moves from the position 2 to a position 3 indicated in FIG. 3, an original orientation 55 of the user 40 is changed by an amount of change in azimuth 57 to an orientation 56. At this time, the user 40 changes the orientation of the mobile terminal 30 by the same amount as that of the change in the orientation of himself/herself. Therefore, an amount of change in azimuth 58 relative to the original orientation 55 of the mobile terminal 30 when the user 40 moved from the position 2 to the position 3 is equal to the amount of change in azimuth 57 of the user 40. There is, accordingly, no difference in orientation between the user 40 and the mobile terminal 30 at the position 3, so that no error occurs in the estimated moving direction of the user 40. On the other hand, in a case where there is created a difference between the amount of change in azimuth 57 of the user 40 and the amount of change in azimuth 58 of the mobile terminal 30, an error occurs in the estimated moving direction of the user 40 in accordance with this difference.

Pedestrian dead reckoning, as described above, is subject to an error in the estimated moving direction of the user 40 when the mobile terminal 30 is rotated to a different direction from the moving direction of the user 40. For this reason, the pedestrian dead reckoning is hard to apply to, for example, a smartphone which changes orientation during movement by being re-held, and to a wearable device or the like of a wrist watch type, which changes orientation when the user 40 moves the arm.

On the other hand, in a case where the mobile terminal 30 is tightly attached to a part of the user 40 (e.g., near body trunk) that hardly changes orientation, the moving direction of the user 40 is estimated more accurately. Also, in a case where the mobile terminal 30 is hand-held by the user 40 such as not to change orientation, similarly, the moving direction of the user 40 is estimated more accurately.

### (3) Comparison Between Inertial Navigation and Pedestrian Dead Reckoning

While inertial navigation and pedestrian dead reckoning have one point in common in that both methods use IMU, the advantages and disadvantages contradict each other due to the difference in the method of estimating the position of the moving body on the basis of the inertial data measured by IMU. For example, no errors occur in inertial navigation even when the moving direction of the user 40 differs from the orientation of the mobile terminal 30. On the other hand, errors occur in pedestrian dead reckoning when the moving direction of the user 40 differs from the orientation of the mobile terminal 30. Further, the inertial navigation entails integration errors because of the use of integration when estimating the position of the moving body. On the other hand, the pedestrian dead reckoning does not use integration when estimating the position of the moving body and does not entail integration errors.

In view of the advantages and disadvantages described above, more accurate position estimation of a moving body is made possible by achieving an apparatus having both features as advantages, i.e., being free of errors even when the moving direction of the user 40 differs from the orientation of the mobile terminal 30, and not using integration when estimating the position of the moving body.

One embodiment of the present disclosure originates from a mindset focusing on the above point. The embodiment of the present disclosure proposes a technique that allows for autonomous improvement of position estimation accuracy through correction of a speed, which is calculated by an inertial navigation system on the basis of inertial data measured by an IMU, with a speed calculated, on the basis of the inertial data, using a characteristic amount of walking.

### (4) Autonomous Position Estimation

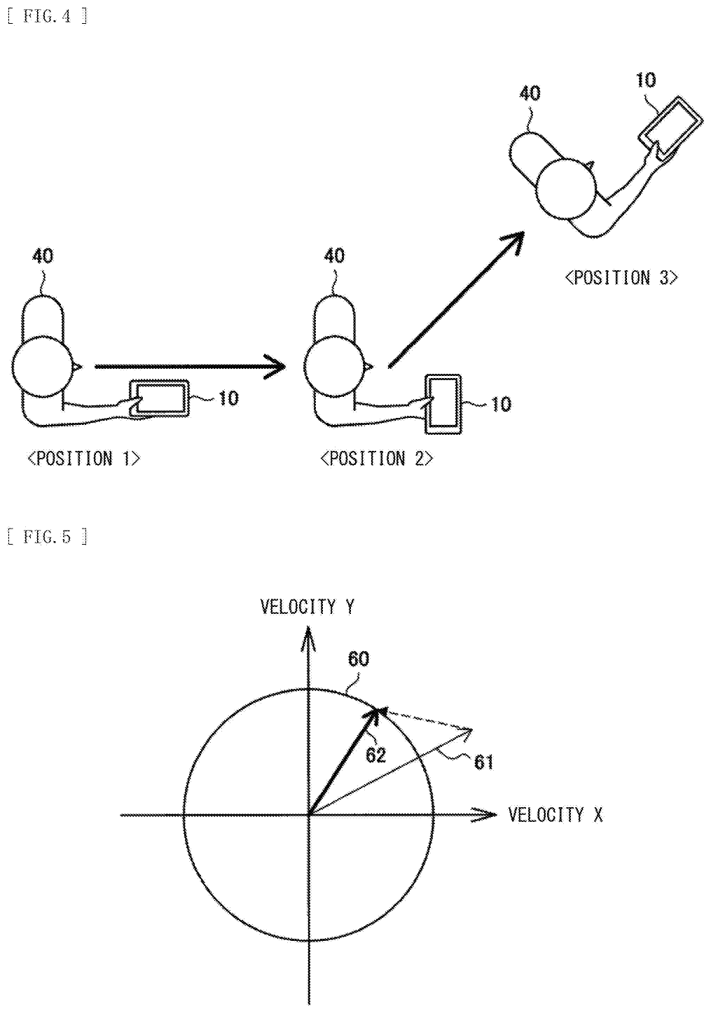

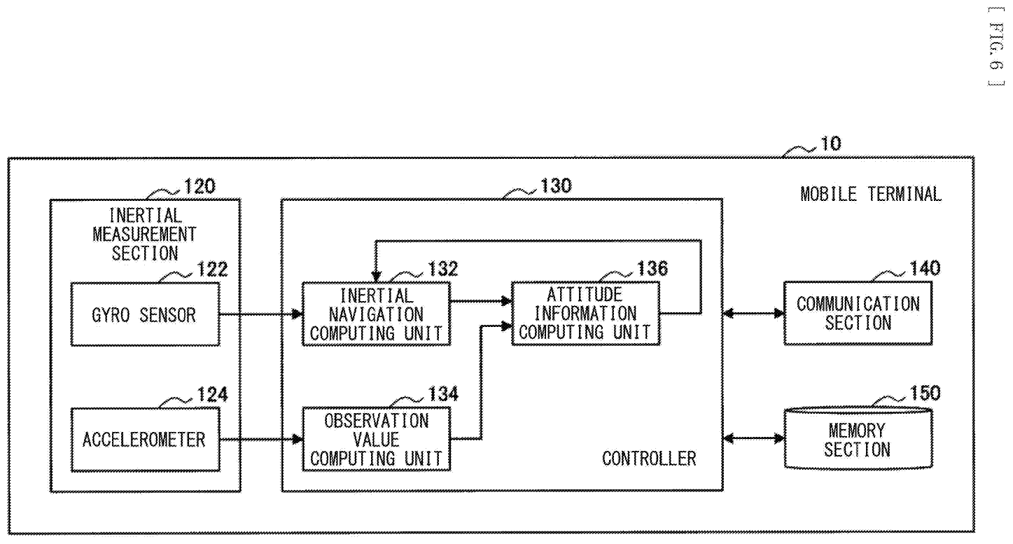

Below, an overview of the embodiment of the present disclosure will be described with reference to FIG. 4 and FIG. 5. FIG. 4 is an explanatory diagram illustrating an overview of one embodiment of the present disclosure. FIG. 5 is an explanatory diagram illustrating an example of correction of a moving speed according to the embodiment of the present disclosure.

A mobile terminal 10 illustrated in FIG. 4 is an information processing apparatus that has a function of estimating a position of itself and of correcting the estimated position on the basis of information acquired by a device equipped in itself. In the embodiment of the present disclosure, as illustrated in FIG. 4, when the user 40 carrying the mobile terminal 10 changes an orientation of the mobile terminal 10 while moving from a position 1 to a position 2, divergence of errors contained in the estimated position of the user 40 is prevented. Moreover, when the user 40 changes each of the orientation of the user 40 himself/herself and the orientation of the mobile terminal 10 while moving from the position 2 to a position 3, divergence of errors contained in the estimated position of the user 40 is prevented.

This is because, in this embodiment of the present disclosure, the characteristic amount of walking (e.g., moving speed or the like) of the user 40 used for the estimation of the position of the user 40 is corrected to a characteristic amount of walking with a smaller error. For example, as illustrated in FIG. 5, a moving speed containing an integration error calculated by an inertial navigation system is indicated by a velocity vector 61. Moreover, the scalar value of speed calculated on the basis of the characteristic amount of walking of the user 40 is represented by a constant-velocity circle 60. In the embodiment of the present disclosure, a corrected velocity vector 62 is calculated by correcting the velocity vector 61 containing the integration error such that the vector is on the constant-velocity circle 60. This way, the moving speed of the user 40, which is calculated on the basis of the inertial data to be used for the estimation of the position of the user 40, is prevented from deviating from an actual moving speed of the user 40.

It is to be noted that the magnitude of the scalar speed calculated on the basis of the stride frequency (hereinafter also referred to as a characteristic amount of walking) and stride length, which are characteristic amounts relating to the movement of the user 40 (hereinafter also referred to as characteristic amounts of movement), corresponds to the radius of the constant-velocity circle 60.

Moreover, the mobile terminal 10 does not use information received from external devices but uses the inertial data measured by its own IMU to correct the velocity vector 61, so that it is possible to estimate the position of the user 40 after autonomously correcting the velocity vector 61. Moreover, the mobile terminal 10 is able to correct the scalar value of speed that has less information than the velocity vector value. Moreover, the mobile terminal 10 is able to correct the angular velocity that is a differential value of the attitude angle.

An overview of the embodiment of the present disclosure has been described above with reference to FIG. 1 to FIG. 5. Next, a functional configuration example of an information processing apparatus according to the embodiment of the present disclosure will be described.

### 1.2. Functional Configuration Example

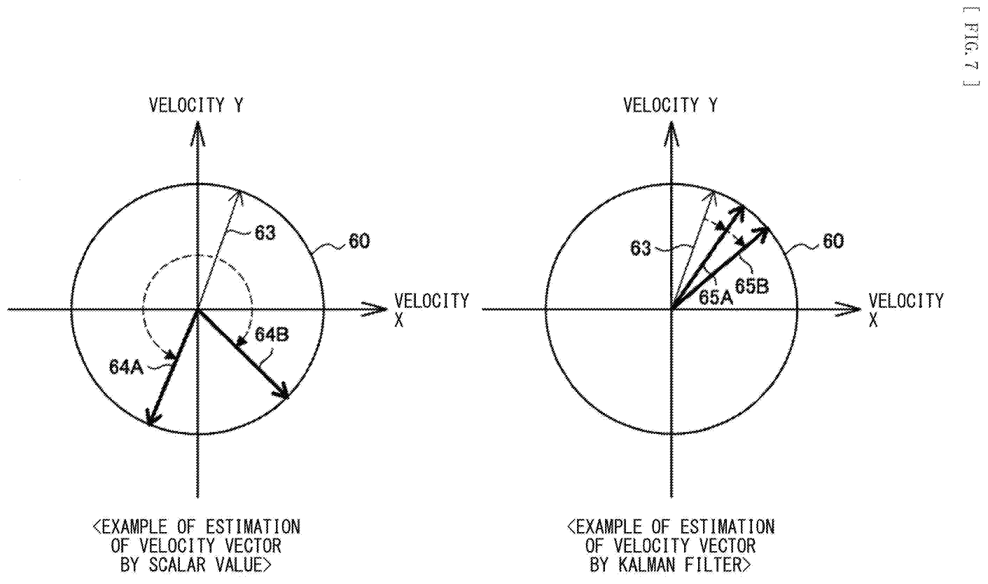

Below, an example of a functional configuration of an information processing apparatus according to the embodiment of the present disclosure will be described with reference to FIG. 6 and FIG. 7. FIG. 6 is a block diagram illustrating an example of a functional configuration of the information processing apparatus according to the embodiment of the present disclosure.

As illustrated in FIG. 6, the mobile terminal 10 according to the embodiment of the present disclosure includes an inertial measurement section 120, a controller 130, a communication section 140, and a memory section 150.

### (1) Inertial Measurement Section 120

The inertial measurement section 120 has a function of measuring inertial data relating to the mobile terminal 10. The inertial measurement section 120 includes an inertial measurement unit (IMU: Inertial Measurement Unit) as a unit that is able to measure inertial data, and outputs inertial data measured by the inertial measurement unit to the controller 130. The inertial measurement section 120 includes a gyro sensor 122 and an accelerometer 124, for example, as inertial measurement units.

### (Gyro Sensor 122)

The gyro sensor 122 is an inertial measurement unit having a function of acquiring an angular velocity of an object. For example, the gyro sensor 122 measures the angular velocity that is the amount of change in the attitude of the mobile terminal 10 as one piece of inertial data.

A mechanical sensor, for example, that obtains the angular velocity from an inertial force applied to a rotating object, is used as the gyro sensor 122. Alternatively, a fluid sensor that obtains the angular velocity from a change in the flow of a gas inside a flow passage may be used as the gyro sensor 122. Alternatively, a sensor that applies a MEMS (Micro Electro Mechanical System) technique may be used as the gyro sensor 122. As described above, the gyro sensor 122 is not limited to a specific type and any type of sensors may be used.

### (Accelerometer 124)

The accelerometer 124 is an inertial measurement unit having a function of acquiring the acceleration of an object. For example, the accelerometer 124 measures the acceleration that is an amount of change in speed when the mobile terminal 10 has moved.

A sensor that obtains the acceleration from changes in position of a weight connected to a spring, for example, is used as the accelerometer 124. Alternatively, a sensor that obtains the acceleration from changes in frequency when vibration is applied to a spring with a weight may be used as the accelerometer 124. Alternatively, a sensor based on a MEMS technique may be used as the accelerometer 124. As described above, the accelerometer 124 is not limited to a specific type and any type of sensors may be used.

### (2) Controller 130

The controller 130 has a function of executing overall control of the mobile terminal 10. For example, the controller 130 controls measurement processes in the inertial measurement section 120.

Also, the controller 130 controls communication processes in the communication section 140. Specifically, the controller 130 causes the communication section 140 to transmit information outputted in accordance with processes executed by the controller 130 to an external device.

Also, the controller 130 controls storage processes in the memory section 150. Specifically, the controller 130 causes the memory section 150 to store information outputted in accordance with the process executed by the controller 130.

The controller 130 also has a function of executing processes on the basis of inputted information. For example, the controller 130 has a function of calculating a status value of the mobile terminal 10 on the basis of inertial data inputted from the inertial measurement section 120 during a movement of the mobile terminal 10. Here, the status value means a value indicative of a moving status of a moving body such as the mobile terminal 10. This status value includes, for example, values indicative of an attitude, a position, and a moving speed of the moving body.

Moreover, the controller 130 has a function of calculating an observation value of the mobile terminal 10 on the basis of inertial data inputted from the inertial measurement section 120 during a movement of the mobile terminal 10. Here, the observation value means a value that contains less error as compared to the status value and more accurately indicates a moving status of the moving body. A moving speed based on a characteristic amount of walking of the moving body, for example, is calculated as the observation value.

Moreover, the controller 130 has a function of calculating attitude information on the basis of the observation value and feeds back the attitude information to the inertial navigation computing unit 132. For example, the controller 130 corrects an attitude value contained in the status value to make a moving speed contained in the status value calculated by the inertial navigation system closer to a moving speed calculated as the observation value. The controller 130 then feeds back the corrected attitude information, and calculates a status value again on the basis of new inertial data and corrected attitude information. Note, in this embodiment of the present disclosure, the attitude information that is fed back after being corrected is a status value corrected on the basis of the observation value.

As described above, the controller 130 corrects the status value calculated on the basis of the inertial data measured by the IMU using the observation value calculated on the basis of the inertial data, which allows for improvement of the accuracy of the status value to be used for position estimation. Moreover, the controller 130 feeds back an attitude value (attitude information) corrected on the basis of the observation value, so that it is possible to improve the accuracy of the status value to be calculated next.

To achieve the functions described above, the controller 130 according to the embodiment of the present disclosure includes, as illustrated in FIG. 6, an inertial navigation computing unit 132, an observation value computing unit 134, and an attitude information computing unit 136.

### (Inertial Navigation Computing Unit 132)

The inertial navigation computing unit 132 has a function of calculating the status value of the moving body by the inertial navigation system. For example, the inertial navigation computing unit 132 calculates the status value of the moving body by the inertial navigation system on the basis of inertial data to be inputted from the inertial measurement section 120. The inertial navigation computing unit 132 then outputs the calculated status value to the attitude information computing unit 136.

Specifically, a status value xi of a moving body to be calculated by the inertial navigation computing unit 132 is expressed by the following expression (1), where Rₗ, Pₗ, and Vₗ respectively represent the attitude, the position, and the speed of the moving body at time l.

[Math. 1]

xₗ=[RₗPₗVₗ] (1)

Note, the method the inertial navigation computing unit 132 uses for calculating the status value of the moving body is not limited, i.e., the status value of the moving body may be calculated using any suitable method. It is to be understood that the inertial navigation computing unit 132 in the embodiment of the present disclosure calculates the status value of the moving body using a common inertial navigation system.

Moreover, the inertial navigation computing unit 132 calculates the status value on the basis of inertial data, as well as the attitude information fed back from the attitude information computing unit 136. For example, the inertial navigation computing unit 132 calculates the status value on the basis of inertial data to be inputted from the inertial measurement section 120, and the attitude information fed back from the attitude information computing unit 136. The inertial navigation computing unit 132 then outputs the calculated status value to the attitude information computing unit 136.

Specifically, a status value xₗ₊₁ of the moving body to be calculated on the basis of the fed-back attitude information at time l+1 is calculated by the following expression (2).

$$\begin{matrix}[ Math . 2 ] & \\ {x}_{l + 1} = [ \begin{matrix}{R}_{l + 1} \\ {P}_{l + 1} \\ {V}_{l + 1}\end{matrix} ] = [ \begin{matrix}Δ R & {0}_{3} & {0}_{3} \\ A ( {a}_{imu} ) & {I}_{3} & {Δ tl}_{3} \\ B ( {a}_{imu} ) & {0}_{3} & {I}_{3}\end{matrix} ] [ \begin{matrix}{R}_{l} \\ {P}_{l} \\ {V}_{l}\end{matrix} ] & ( 2 )\end{matrix}$$

Here, [Rₗ Pₗ Vₗ] in the expression (2) represents the status value fed back from the attitude information computing unit 136. Further, 0₃ in the expression (2) represents a 3×3 zero matrix. Further, 3 represents a 3×3 unit matrix. Further, A(aᵢₘᵤ) and B(aᵢₘᵤ) represent terms that calculate position and speed based on acceleration, aᵢₘᵤ representing the acceleration measured by the IMU. Further, Δt represents a sampling cycle when the IMU measures inertial data. Further, ΔR is a term indicative of an error in the attitude value when the moving body has moved during a period from time l to time l+1, and is calculated by the following expression (3).

[Math. 3]

ΔR=¬ₗ^{l+1}(ωᵢₘᵤ(τ)−b_{gyr}(τ))dₜ (3)

Here, ωᵢₘᵤ(τ) in the expression (3) represents the attitude value calculated on the basis of the angular velocity measured by the IMU, and b_{gyr}(τ) represents the attitude value calculated on the basis of a bias of the gyro sensor.

### (Observation Value Computing Unit 134)

The observation value computing unit 134 has a function of calculating the observation value of the moving body. For example, the observation value computing unit 134 calculates the observation value of the moving body on the basis of a characteristic amount of movement calculated on the basis of inertial data to be inputted from the inertial measurement section 120. The observation value computing unit 134 then outputs the calculated observation value to the attitude information computing unit 136. The observation value computing unit 134 according to the embodiment of the present disclosure uses a value relating to a moving speed of the moving body as the observation value. Moreover, the observation value computing unit 134 calculates this observation value on the basis of a characteristic amount of movement relating to a movement of the moving body. For example, in a case where the moving body is a walking moving body, the characteristic amount of movement the observation value computing unit 134 uses is a stride frequency detected on the basis of an acceleration of the pedestrian measured by the inertial measurement section 120. The stride frequency indicates a characteristic specific to the pedestrian. The characteristic amount of movement indicative of a characteristic amount specific to the pedestrian will be referred to also as a characteristic amount of walking below. It should be noted that any value relating to a moving speed of a moving body may be set as the observation value.

A Case where the Observation Value is a Walking Speed

The value relating to the moving speed of the moving body is, for example, a walking speed of a pedestrian. The observation value computing unit 134 uses a walking speed of the pedestrian that is calculated on the basis of the stride frequency of the moving body and the stride length of the moving body as the observation value. Specifically, the observation value computing unit 134 uses a characteristic amount of walking and the calculation expression, (stride length)×(stride frequency), to calculate the observation value. The stride frequency is calculated highly accurately by using a step counting algorithm. Moreover, the stride length may be a predetermined value, may be a value to be preset, or may be calculated on the basis of information received from a GNSS.

A Case where the Observation Value is an Amount of Change in Speed Based on the Stride Frequency

Moreover, the value relating to the moving speed of the moving body may be an amount of change in walking speed calculated on the basis of the stride frequency of the pedestrian. In a case where it is determined that the pedestrian is moving at a constant speed on the basis of the stride frequency of the pedestrian, the observation value computing unit 134 may use a value indicating that the amount of change in speed is zero as the observation value. Specifically, in a case where the observation value computing unit 134 determines that the pedestrian is moving at a constant speed on the basis of the stride frequency of the pedestrian, the observation value computing unit 134 outputs zero as the observation value to the attitude information computing unit 136. Moreover, in a case where the observation value computing unit 134 determines that the pedestrian is not moving at a constant speed on the basis of the stride frequency, the observation value computing unit 134 may calculate the amount of change in speed and output the calculated amount of change in speed as the observation value to the attitude information computing unit 136.

A Case where the Observation Value is an Amount of Change in Speed Based on a Judgment Result on Walking

Moreover, the value relating to the moving speed of the moving body may be an amount of change in speed calculated on the basis of a result of judgment on walking. In a case where the observation value computing unit 134 determines that the pedestrian is walking on the basis of inertial data, a value indicating that the amount of change in speed of the pedestrian is zero may be used as the observation value. Specifically, in a case where the observation value computing unit 134 determines that the pedestrian is walking on the basis of an acceleration, the observation value computing unit 134 assumes that the pedestrian is walking at a constant speed and outputs zero as the observation value to the attitude information computing unit 136. As described above, predefining that the amount of change in speed is zero if the pedestrian is walking allows for simpler processing in the observation value computing unit 134.

Here, the inertial data the observation value computing unit 134 uses for calculation of the observation value is not limited to the acceleration to be inputted from the inertial measurement section 120, and an angular velocity may be used. Note, inertial data values the observation value computing unit 134 uses for calculation of the observation value are basically scalar values. Therefore, the calculated observation values are also scalar values. Instead, inertial data values the observation value computing unit 134 uses for calculation of the observation value may be vector values. Use of vector values enables the observation value computing unit 134 to improve the accuracy of calculated observation values.

### (Attitude Information Computing Unit 136)

The attitude information computing unit 136 has a function of calculating the attitude information on the basis of the status value and the observation value. For example, the attitude information computing unit 136 calculates the attitude information by correcting the status value on the basis of the observation value. Specifically, the attitude information computing unit 136 corrects an attitude value contained in the status value to make a moving speed contained in the status value inputted to the inertial navigation computing unit 132 closer to a moving speed the observation value inputted to the observation value computing unit 134 indicates. The attitude information computing unit 136 then feeds back the corrected status value to the inertial navigation computing unit 132 as the attitude information. Here, with the corrected status value being fed back, the inertial navigation computing unit 132 is able to update [Rₗ Pₗ Vₗ] in the expression (2) given above, on the basis of the attitude value of the corrected status value, as a more accurate status value xₗ. Thus, with the inertial navigation computing unit 132 being able to calculate a more accurate status value xₗ₊₁, the controller 130 is able to autonomously improve the accuracy of position estimation.

The attitude information computing unit 136 according to the embodiment of the present disclosure is achieved by a Kalman filter, for example. An application example of the Kalman filter according to the embodiment of the present disclosure will now be described with reference to FIG. 7. FIG. 7 is an explanatory diagram illustrating the effect of the Kalman filter according to the embodiment of the present disclosure. The diagram on the left side in FIG. 7 illustrates an estimation example of a velocity vector based on a scalar value. The diagram on the right side in FIG. 7 illustrates an estimation example of a velocity vector based on the Kalman filter. It should be noted that the example described below assumes a case where the observation value is a walking speed.

Application of Kalman Filter

In the embodiment of the present disclosure, the observation values the observation value computing unit 134 inputs to the attitude information computing unit 136 are scalar values. The scalar speed calculated on the basis of the scalar value is represented by a constant-velocity circle 60. The velocity vector after correction to be estimated on the basis only of the observation value that is a scalar value can be estimated as a velocity vector on a given point on the constant-velocity circle 60, as a velocity vector 64A or a velocity vector 64B illustrated in the diagram on the left side in FIG. 7. This is because the observation value is not a vector value so that the attitude information computing unit 136 is not able to uniquely determine the direction of moving speed after the correction.

On the other hand, in a case where the Kalman filter is applied to the attitude information computing unit 136, the Kalman filter, which performs serial processing, is able to estimate a velocity vector after correction so as not to deviate from the constant-velocity circle 60 that has been calculated on the basis of the observation value that is a scalar value. For example, it is possible to correct the velocity vector after correction sequentially to a velocity vector 65A and to a velocity vector 65B, on the basis of the velocity vector 63 that is a true value, as illustrated in the diagram on the right side in FIG. 7. This is because the processing performed by the Kalman filter is a serial process and the time interval between samples used in the serial process is short so that changes in direction between samples are extremely small.

Algorithm of Kalman Filter

The attitude information computing unit 136 (hereinafter also referred to as Kalman filter) corrects the status value calculated by the inertial navigation computing unit 132 on the basis of the observation value. The Kalman filter then calculates a corrected status value, and feeds back the corrected status value to the inertial navigation computing unit 132 as the attitude information. Specifically, the corrected status value xi to be calculated by the attitude information computing unit 136 is calculated by the following expression (4).

[Math. 4]

x_{l′}=xₗ+(K·y)^{T} (4)

Here, xₗ in the expression (4) represents the status value before correction. Further, K represents a Kalman gain. Kalman gain is a value that determines the extent to which the observation value is to be reflected to the status value before correction. Note, the Kalman gain K is calculated on the basis of the following expression (5).

$$\begin{matrix}[ Math . 5 ] & \\ H [ \begin{matrix}{R}_{l} \\ {P}_{l} \\ {V}_{l}\end{matrix} ] & ( 5 )\end{matrix}$$

Here, H in the expression (5) represents a Jacobian determinant. The Jacobian determinant H is determined such that the dimensions and coordinate systems of the status value before correction and the observation value match each other.

Moreover, y in the expression (4) represents a difference between a moving speed of the moving body (third moving speed) included in the status value before the correction, and a moving speed of the moving body (fourth moving speed) included in the observation value. The Kalman filter calculates the corrected status value on the basis of this difference. Note, this difference is calculated by the following expression (6).

[Math. 6]

y=[v_{ob_norm}−v_{exp_norm}] (6)

Here, v_{ob_norm} in the expression (6) represents a scalar value of a value (observation value) relating to a moving speed (walking speed) calculated by the observation value computing unit 134 from a characteristic amount of walking. Moreover, v_{exp_norm} represents a moving speed included in the status value calculated by the inertial navigation computing unit 132 using the inertial navigation system. Note, v_{exp_norm} is calculated by the following expression (7).

[Math. 7]

v_{exp_norm}=\sqrt{vₓₗ²+v_{yl}²} (7)

Here, vₓₗ in the expression (7) represents a moving speed component in the pitch axis direction of the moving body. Moreover, v_{yl} represents a moving speed component in the roll axis direction of the moving body. Note, vxd may represent the moving speed component in the roll axis direction and v_{yl} may represent the moving speed component in the pitch axis direction.

### (3) Communication Section 140

The communication section 140 has a function of communicating with an external device. For example, the communication section 140 outputs information received from the external device during communications with the external device to the controller 130. Also, during communications with the external device, the communication section 140 transmits information inputted from the controller 130 to the external device.

### (4) Memory Section 150

The memory section 150 has a function of storing data obtained by the processing in the information processing apparatus. For example, the memory section 150 stores inertial data measured by the inertial measurement section 120. Specifically, the memory section 150 stores the acceleration and the angular velocity of the mobile terminal 10 measured by the inertial measurement section 120.

Note, the information stored in the memory section 150 is not limited to the inertial data described above. For example, the memory section 150 may store data outputted in the processing by the controller 130, programs such as various applications, and data or the like.

One example of the functional configuration of the mobile terminal 10 according to the embodiment of the present disclosure has been described above with reference to FIG. 6 and FIG. 7. Next, an operation example of the mobile terminal 10 according to the embodiment of the present disclosure will be described.

### 1.3. Operation Example

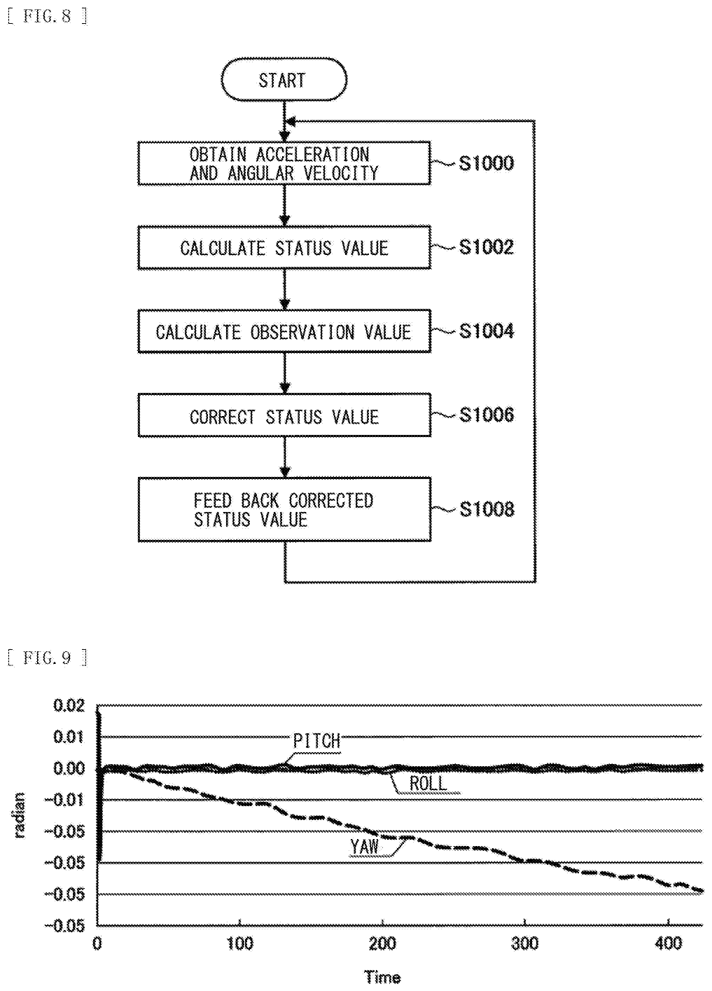

Below, an operation example of the mobile terminal 10 according to the embodiment of the present disclosure will be described with reference to FIG. 8. FIG. 8 is a flowchart illustrating an example of operation of the mobile terminal 10 when the Kalman filter is applied according to the embodiment of the present disclosure.

As illustrated in FIG. 8, first, the inertial measurement section 120 obtains an acceleration and an angular velocity (step S1000). The inertial navigation computing unit 132 calculates a status value by an inertial navigation system on the basis of the acceleration and angular velocity obtained by the inertial measurement section 120 (step S1002). The observation value computing unit 134 calculates an observation value on the basis of an acceleration, or a characteristic amount of walking (step S1004).

After the status value and the observation value have been calculated, the attitude information computing unit 136 corrects the status value calculated by the inertial navigation computing unit 132 on the basis of the observation value calculated by the observation value computing unit 134 (step S1006). After the correction of the status value, the attitude information computing unit 136 feeds back the corrected status value to the inertial navigation computing unit 132 (step S1008).

After the feedback of the corrected status value, the mobile terminal 10 repeats the process from step S1000 to step S1008 described above. Note, at step S1002, the inertial navigation computing unit 132 calculates the status value on the basis of the acceleration and the angular velocity obtained by the inertial measurement section 120, and the corrected status value. As described above, by repeatedly performing the process from step S1000 to step S1008 described above, the mobile terminal 10 is able to improve the accuracy of position estimation more. Note, the mobile terminal 10 may end the process from step S1000 to step S1008 described above at any suitable timing.

One operation example of the mobile terminal 10 according to the embodiment of the present disclosure has been described above with reference to FIG. 8. Next, a test example according to the embodiment of the present disclosure will be described.

### 1.4. Test Examples

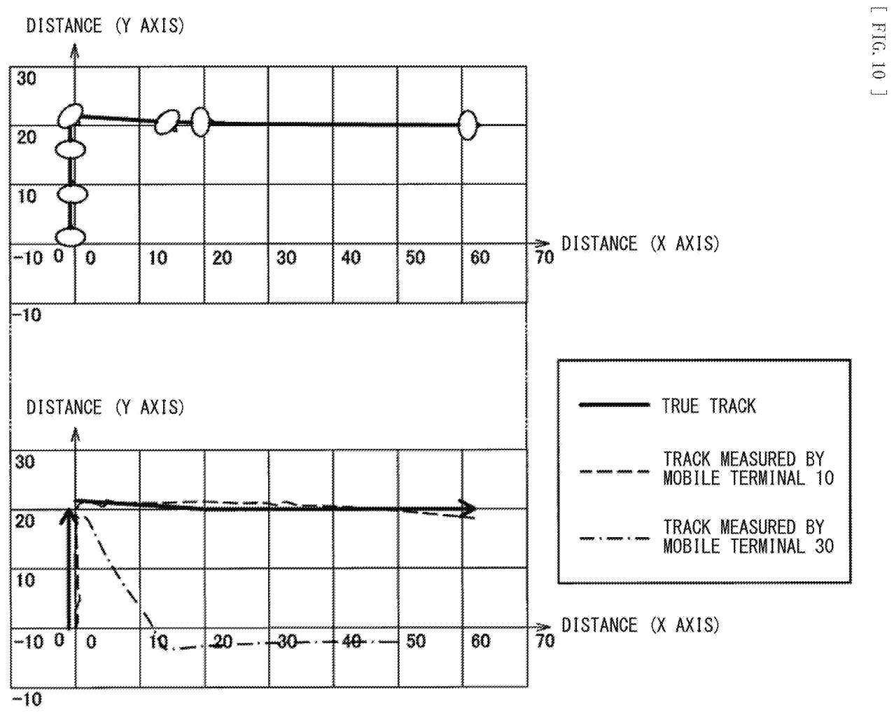

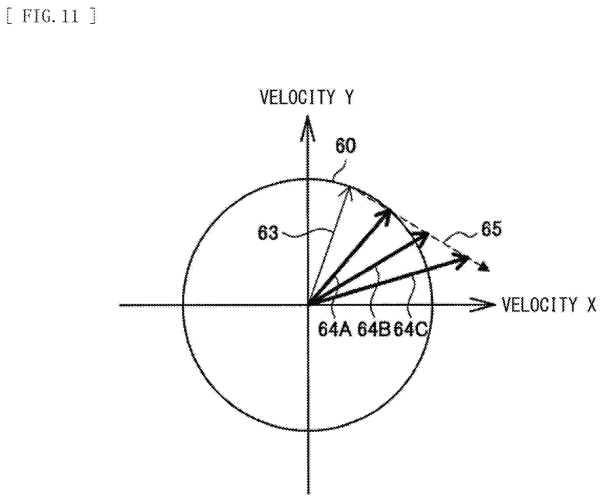

Below, test examples according to the embodiment of the present disclosure will be described with reference to FIG. 9 and FIG. 10.

### (1) Attitude Correction

Below, a test result on correction of the attitude of the moving body according to the embodiment of the present disclosure will be described with reference to FIG. 9. FIG. 9 is an explanatory diagram illustrating an example of correction of an attitude of a moving body according to the embodiment of the present disclosure. The graph in FIG. 9 indicates a result of a test based on virtual inertial data when it is assumed that the pedestrian walks straight ahead. The vertical axis of the graph represents the angle of attitude error, and the horizontal axis represents the time. Moreover, changes with time in the attitude value around the pitch axis as the rotation axis are indicated with a solid line. Moreover, changes with time in the attitude value around the roll axis as the rotation axis are indicated with a dot line. Moreover, changes with time in the attitude value around the yaw axis as the rotation axis are indicated with a broken line.

Here, the gyro sensor has a bias of 1×10⁻⁴ rad/s set to all three axes. Therefore, in a case where the status value calculated by the inertial navigation computing unit 132 is not corrected, the attitude error corresponding to the bias accumulates progressively as time passes in the attitude values of all three axes.

In this test, however, the attitude values around the pitch axis and the roll axis as the rotation axes are the targets of correction. Therefore, as the graph of FIG. 9 indicates, there is hardly any attitude error in the attitude values around the pitch axis and the roll axis as the rotation axes that are the correction targets. Also indicated is that the attitude error corresponding to the bias is accumulated as time passes only in the attitude value around the yaw axis as the rotation axis, which is not the correction target.

### (2) Position Correction

Below, a test result on correction of the position of a moving body according to the embodiment of the present disclosure will be described with reference to FIG. 10. FIG. 10 is an explanatory diagram illustrating an example of correction of a position of a moving body according to the embodiment of the present disclosure. The diagram on the upper side in FIG. 10 illustrates an example of a walk when a pedestrian walks with an IMU attached to the head. The diagram on the lower side in FIG. 10 illustrates walking tracks measured as a result of the pedestrian's walk.

The vertical axis in each graph indicates the moving distance from the origin in the Y-axis direction, and the horizontal axis indicates the moving distance from the origin in the X-axis direction. A solid line in the graph on the lower side in FIG. 10 indicates a true track of the pedestrian. A broken line in the graph on the lower side in FIG. 10 indicates a track of the pedestrian measured by the mobile terminal 10. The one-dot chain line in the graph on the lower side in FIG. 10 indicates a track of the pedestrian measured by the mobile terminal 30. It should be noted that the comparative example uses only pedestrian dead reckoning to estimate the position of the pedestrian.

In this test, as illustrated in the diagram on the upper side in FIG. 10, the pedestrian, located at first at coordinates (0, 0) as a point of start of the walk (origin), walks straight to coordinates (0, 20). At coordinates (0, 20), the pedestrian turns the body clockwise by exactly 90 degrees to change the moving direction. At this time, the pedestrian also turns the head clockwise by exactly 135 degrees to change the direction of the head. After changing the moving direction, the pedestrian walks further straight from coordinates (0, 20), and turns the head counterclockwise by exactly 45 degrees at coordinates (15, 20) to change the direction of the head again. After changing the direction of the head, the pedestrian keeps walking straight to coordinates (60, 20).

As illustrated in the diagram on the lower side in FIG. 10, no deviation from the true track occurs both in the track according to the embodiment of the present disclosure and in the track according to the comparative example when the pedestrian walks from coordinates (0, 0) to coordinates (0, 20). When the pedestrian walks from coordinates (0, 20) to coordinates (60, 20), hardly any deviation from the true track occurs in the track according to the embodiment of the present disclosure. On the other hand, in the track according to the comparative example from coordinates (0, 20) to coordinates (15, 20), the angle at which the head was turned has caused a deviation from the true track. Moreover, after the head direction was changed again at coordinates (15, 20), the track according to the comparative example is parallel to the true track because error divergence has stopped.

As described above, it is appreciated that, in the comparative example, the turning of the head more than the body had an influence and the angle at which the head was rotated more than the body led to a deviation from the track. On the other hand, it is appreciated that, in the embodiment of the present disclosure, the influence caused by the turning of the head more than the body is reduced.

One embodiment of the present disclosure has been described above with reference to FIG. 1 to FIG. 10. Next, test examples according to the embodiment of the present disclosure will be described.

### 2. Modification Examples

Below, modification examples of the embodiment of the present disclosure will be described. It should be noted that the modification examples described below may be applied to the embodiment of the present disclosure alone, or applied to the embodiment of the present disclosure in combination. Moreover, the modification examples may be applied in place of a configuration described in the embodiment of the present disclosure, or may be applied in addition to a configuration described in the embodiment of the present disclosure.

### (1) First Modification Example

Below, a first modification example according to the embodiment of the present disclosure will be described with reference to FIG. 11 to FIG. 13. In the embodiment described above, one example in which the attitude information computing unit 136 calculates attitude information using the Kalman filter has been described. In the first modification example, one example in which the attitude information computing unit 136 calculates attitude information without using the Kalman filter will be described. Instead of using the Kalman filter, the attitude information computing unit 136 in the first modification example uses a constraint to calculate an optimal value of attitude error, and uses this optimal value of attitude error as the attitude information.

### (Application of Constraint)

First, application of a constraint in the first modification example according to the embodiment of the present disclosure will be described with reference to FIG. 11. FIG. 11 is an explanatory diagram illustrating an example of application of a constraint according to the embodiment of the present disclosure. It should be noted that the description below presupposes that the moving body moves in one direction at a constant speed. As illustrated in FIG. 11, the scalar speed calculated on the basis of the observation value that is a scalar value is to be represented by a constant-velocity circle 60. In a case where the gyro sensor of the IMU has sufficient accuracy, the attitude error that occurs in a short period of time and the direction of acceleration of the moving body caused by the gravity cancel error are substantially constant. The direction of acceleration is constant, as indicated as a direction of acceleration 65 in FIG. 11, for example. However, the amount of attitude error that occurs is not constant, so that the amount of attitude error diverges as time passes. Therefore, as illustrated in FIG. 11, the corrected velocity vector changes from a velocity vector 64A to a velocity vector 64B, and to a velocity vector 64C, deviating from the constant-velocity circle 60. Accordingly, the attitude information computing unit 136 sets a constraint that the attitude error in a predetermined period of time is constant to allow the corrected velocity vector to be converged on the constant-velocity circle 60.

### Constraint in First Modification Example

The attitude information computing unit 136 in the first modification example uses a constraint to calculate an optimal value of attitude error, and uses this optimal value of attitude error as the attitude information. For example, the attitude information computing unit 136 uses a constraint that the attitude error in a predetermined period of time is constant. This constraint enables the attitude information computing unit 136 to estimate a correct attitude and orientation of the moving body even though the inputted status value and observation value are scalar values.

Specifically, in a case where the predetermined time is set to 10 seconds, the attitude information computing unit 136 calculates an attitude error value that minimizes the difference between the status value and the observation value under the constraint, on the basis of the moving speeds included in each of the status value and the observation value that are calculated on the basis of a plurality of sets of inertial data measured by the IMU in 10 seconds. The attitude information computing unit 136 then feeds back this attitude error value to the inertial navigation computing unit 132 as the attitude information.

Note, in the first modification example, the attitude error value fed back from the attitude information computing unit 136 as the attitude information is used by the inertial navigation computing unit 132 for correcting the attitude value contained in the status value.

Note, the moving speed contained in the status value will be referred to also as status value speed below. Also, the moving speed contained in the observation value will be referred to also as observation value speed below.

Note, the predetermined time is not limited to the example described above, and any suitable period of time may be set. Here, in this modification example, the sampling rate of the IMU is set to 100 Hz. Therefore, when the predetermined time is set to 10 seconds, 1000 samples of inertial data are taken in 10 seconds. Note, the sampling rate is not limited to the example described above, and any suitable sampling rate may be set.

### (Optimal Attitude Error Search Process)

The attitude information computing unit 136 assigns a provisional error value to the status value calculated by the inertial navigation computing unit 132 to be used as a provisional status value. Then, an amount of correction for the status value is calculated on the basis of a degree of divergence between the provisional status value and the observation value calculated by the observation value computing unit 134. The attitude information computing unit 136 then feeds back the amount of correction to the inertial navigation computing unit 132 as attitude information.

In this modification example, a provisional error value (hereinafter also referred to as provisional attitude error) is assigned to each components in the roll axis direction and the pitch axis direction of the attitude value contained in the status value. The provisional attitude error of the component in the roll axis direction of the attitude value is represented by θ_{err_pitch}, and the provisional attitude error of the component in the pitch axis direction of the attitude value is represented by θ_{err_roll}.

More specifically, the attitude information computing unit 136 calculates the degree of divergence between each of a plurality of provisional status values calculated on the basis of a plurality of sets of inertial data measured within a predetermined time and the observation value corresponding to the each of the plurality of provisional status values while varying the provisional error value, and determines a provisional error value that minimizes the degree of divergence as the amount of correction. For example, the attitude information computing unit 136 calculates provisional status values by assigning error values θ_{err_pitch} and θ_{err_roll} varied in a predetermined increment at each step in a range of degrees from −1 to 1 to one status value that is calculated on the basis of one sample of inertial data. In a case where the predetermined increment dθ is set to 0.01 degree, the attitude information computing unit 136 assigns θ_{err_pitch} varied at each step by an increment of 0.01 degree from −1 degree to 1 degree, so that 200 provisional status values are calculated. Similarly, 200 provisional status values θ_{err_roll} are calculated. Note, the predetermined increment dθ is not limited to the example described above, and any suitable value may be set.

Moreover, the number of degrees of divergence that are calculated is identical to the number of combinations of status values calculated by assigning provisional attitude errors to each of θ_{err_pitch} and θ_{err_roll}. In this modification example, the number of degrees of divergence that the attitude information computing unit 136 calculates is identical to the number of combinations of 200 provisional status values calculated on the basis of θ_{err_pitch} and 200 provisional status values calculated on the basis of θ_{err_roll}. Namely, 40000 (200 times 200) degrees of divergence are calculated. The attitude information computing unit 136 then selects the smallest one from the calculated 40000 degrees of divergence and determines the combination of θ_{err_pitch} and θ_{err_roll} for this degree of divergence as the optimal attitude error value (correction amount).

The degree of divergence is calculated on the basis of a status value speed contained in the provisional status value (first moving speed) and an observation value speed contained in the observation value corresponding to the provisional status value (second moving speed). Specifically, the attitude information computing unit 136 calculates a square of a difference between the absolute value of the status value speed and the observation value speed, the number of the calculated squares of the differences being identical to the number of measurement values measured within a predetermined period of time, and determines a mean value of the plurality of calculated squares of the differences, as the degree of divergence.

More specifically, first, the attitude information computing unit 136 calculates the status value speed for each sample with one of 40000 combinations of θ_{err_pitch} and θ_{err_roll}. The attitude information computing unit 136 calculates the square of the difference between the absolute value of the status value speed calculated for each sample and the observation value speed calculated by the observation value computing unit 134. The attitude information computing unit 136 repeats this process of calculating the square of the difference for 1000 samples. Then, the attitude information computing unit 136 calculates the mean value of the total sum S of the calculated squares of the differences for 1000 samples. This mean value is determined as the degree of divergence (RMS: Root Means Square).

Here, the values such as the sampled inertial data, the status value speeds calculated on the basis of the inertial data, the total sum S of squares of differences, and the degree of divergence (RMS) are buffered (stored) in the memory section 150.

### Operation Example in the First Modification Example

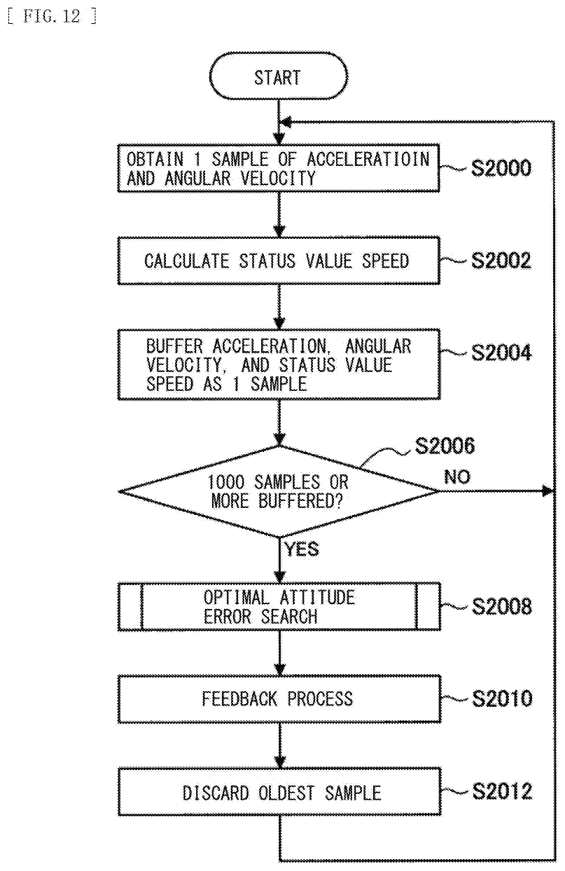

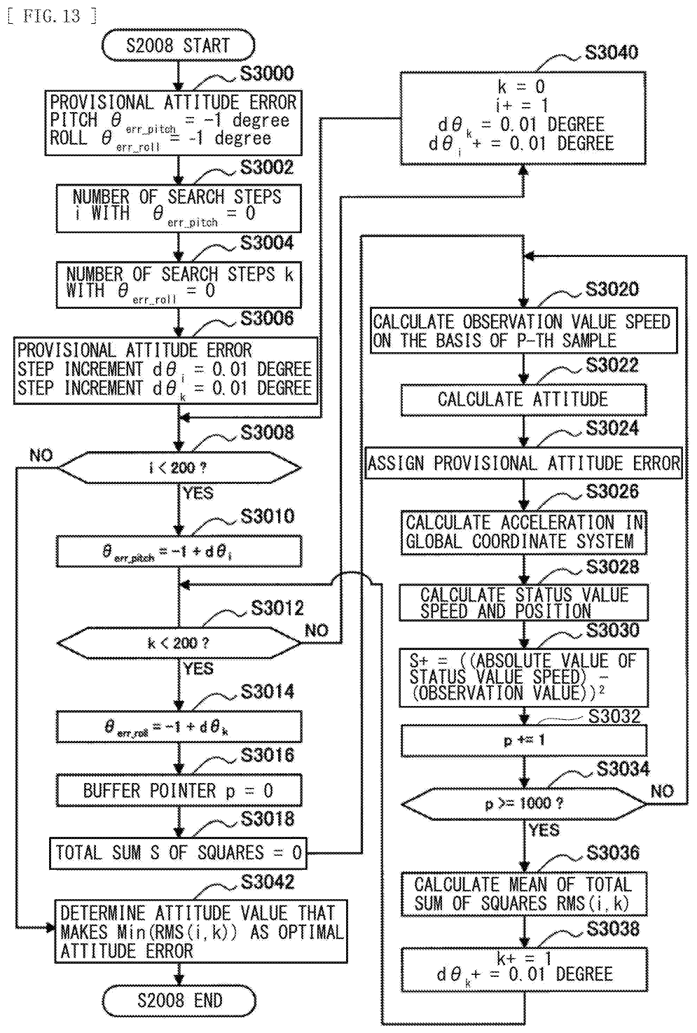

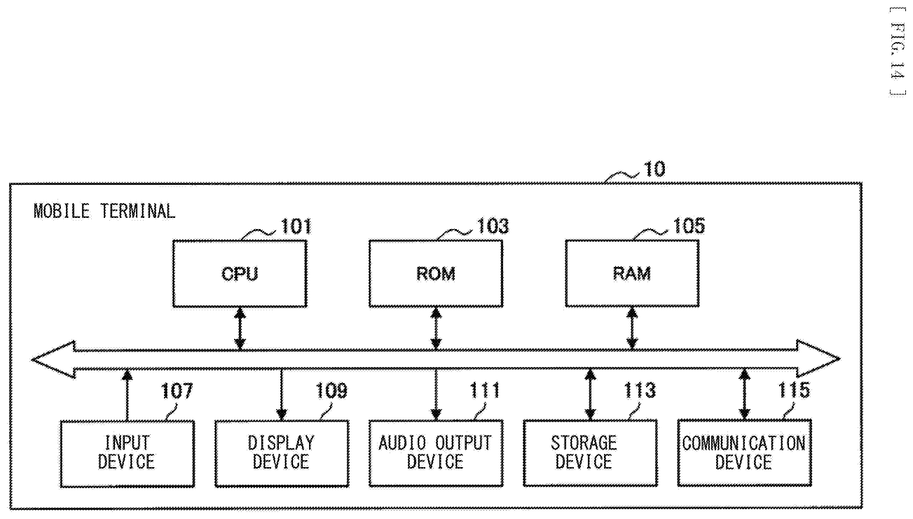

Below, an operation example of the mobile terminal 10 in the first modification example according to the embodiment of the present disclosure will be described with reference to FIG. 12 and FIG. 13. FIG. 12 is a flowchart illustrating an example of operation of the mobile terminal 10 when the constraint is applied according to the embodiment of the present disclosure. FIG. 13 is a flowchart illustrating an example of a process of searching for an optimal attitude error when a constraint is applied according to the embodiment of the present disclosure.

### (Main Process)

As illustrated in FIG. 12, first, the inertial measurement section 120 obtains one sample of acceleration and angular velocity (step S2000). The inertial navigation computing unit 132 of the controller 130 calculates a status value speed on the basis of the acceleration and the angular velocity obtained by the inertial measurement section 120 (step S2002). The controller 130 associates the acceleration and the angular velocity obtained by the inertial measurement section 120, and the status value speed calculated by the inertial navigation computing unit 132 with each other as one sample, and buffers the sample in the memory section 150 (step S2004).

After buffering the sample, the controller 130 checks whether or not 1000 samples or more have been buffered (step S2006). In a case where 1000 or more samples have not been buffered (No at step S2006), the controller 130 repeats the process from step S2000 to step S2004. In a case where 1000 or more samples have been buffered (Yes at step S2006), the controller 130 performs the process of searching for an optimal attitude error (step S2008). Note, a detailed process flow of the optimal attitude error search process will be described later.

After the optimal attitude error search process, the attitude information computing unit 136 in the controller 130 feeds back the optimal attitude error to the inertial navigation computing unit 132 (step S2010). After the feedback, the controller 130 discards the oldest one of the samples (step S2012), and repeats the process described above from step S2000.

### (Optimal Attitude Error Search Process)

As illustrated in FIG. 13, the controller 130 first performs an initialization process for performing the optimal attitude error search process. As the initialization process, the controller 130 sets each of the provisional attitude errors θ_{err_pitch} and θ_{err_roll} to −1 degree (step S3000). The controller 130 also sets the number of search steps i with θ_{err_pitch} to 0 (step S3002). The controller 130 also sets the number of search steps k with θ_{err_roll} to 0 (step S3004). The controller 130 also sets the increment angles of provisional attitude errors, i.e., an increment angle dθᵢ of 0.01 degree for θ_{err_pitch} and an increment angle dθₖ of 0.01 degree for θ_{err_roll} (step S3006).

After the initialization process, the controller 130 checks whether or not the number of search steps i is less than 200 (step S3008). In a case where the number of search steps i is less than 200 (YES at step S3008), the controller 130 increments θ_{err_pitch} by dθᵢ (step S3010). In a case where the number of search steps i is not less than 200 (No at step S3008), the controller 130 performs the process of step S3042 to be described later.

After incrementing by dθᵢ, the controller 130 checks whether or not the number of search steps k is less than 200 (step S3012). In a case where the number of search steps k is less than 200 (YES at step S3012), the controller 130 increments θ_{err_roll} by dθₖ (step S3014). In a case where the number of search steps k is not less than 200 (No at step S3012), the controller 130 performs the process of step S3040 to be described later.

After incrementing by dθₖ, the controller 130 resets a buffer pointer p, which indicates which of the plurality of sampled inertial data sets is being processed, to zero (step S3016). Also, the controller 130 resets the total sum S of squares to zero (step S3018).

After resetting the total sum S of squares, the controller 130 calculates an observation value speed on the basis of the inertial data that is a p-th one of the sampling data that has been buffered (step S3020). After calculating the observation value, the controller 130 calculates an attitude value of the mobile terminal 10 on the basis of the p-th inertial data (step S3022), and assigns the provisional attitude error to this attitude value (step S3024). The controller 130 performs global coordinate conversion on the basis of the attitude value to which the provisional attitude error has been assigned, to calculate an acceleration in the global coordinate system (step S3026). The controller 130 calculates a status value speed and a position on the basis of the calculated acceleration in the global coordinate system (step S3028). The controller calculates the square of a difference between the absolute value of the status value speed and the observation value speed, adds the calculated square of the difference to the total sum S of squares, thus updating the total sum S of squares (step S3030). After updating the total sum S of squares, the controller 130 increments the buffer pointer p by 1, thus updating the buffer pointer (step S3032).

After updating the buffer pointer p, the controller 130 checks whether or not the buffer pointer p is 1000 or more (step S3034). In a case where the buffer pointer p is not 1000 or more (No at step S3034), the controller 130 repeats the process from step S3020 to step S3032 described above. In a case where the buffer pointer p is 1000 or more (Yes at step S3034), the controller 130 calculates the degree of divergence RMS (i, k) that is a mean value of the total sum of squares (step S3036). After calculating the degree of divergence RMS (i, k), the controller 130 increments the number of search steps k by 1, and increments the increment angle dθₖ by 0.01 degree (step S3038).

After executing step S3038, the controller 130 performs step S3012 again to check whether or not the number of search steps k is less than 200 (step S3012). In a case where the number of search steps k is less than 200 (Yes at step S3012), the controller 130 repeats the process from step S3014 to step S3038 described above. In a case where the number of search steps k is not less than 200 (No at step S3012), the controller 130 resets the number of search steps k to 0, and resets the increment angle dθₖ to 0.01 degree (step S3040). Also, the controller 130 increments the number of search steps i by 1, and increments the increment angle d by 0.01 degree (step S3040).

After executing step S3040, the controller 130 performs step S3008 again to check whether or not the number of search steps i is less than 200 (step S3008). In a case where the number of search steps i is less than 200 (Yes at step S3008), the controller 130 repeats the process from step S3008 to step S3040 described above. In a case where the number of search steps i is not less than 200 (No at step S3008), the controller 130 determines the attitude value with which the degree of divergence RMS (i, k) is the smallest as an optimal attitude error (step S3042), and ends the optimal attitude error search process.

### (2) Second Modification Example

While one example has been described in the embodiment above in which the moving body is a pedestrian, the moving body may be a car. This is because there exists an algorithm by which observation values relating to the car are calculated. Applying this algorithm to the observation value computing unit 134 allows the controller 130 to prevent error divergence in the position estimation similarly to the embodiment described above.

### (3) Third Modification Example

While one example has been described in the embodiment above in which the moving body walks, the moving body may swim. This is because swimming involves cyclic motions as with walking. The observation value computing unit 134 is able to calculate the moving speed of a swimmer as the observation value on the basis of the cycle of strokes.

Modification examples of the embodiment of the present disclosure have been described above with reference to FIG. 11 to FIG. 13. Next, a hardware configuration of the information processing apparatus according to the embodiment of the present disclosure will be described.

### 3. HARDWARE CONFIGURATION EXAMPLE

Below, a hardware configuration example of the mobile terminal 10 according to the embodiment of the present disclosure will be described with reference to FIG. 14. FIG. 14 is a block diagram illustrating an example of a hardware configuration of the mobile terminal 10 according to the embodiment of the present disclosure. As illustrated in FIG. 14, the mobile terminal 10 includes, for example, a CPU 101, a ROM 103, a RAM 105, an input device 107, a display device 109, an audio output device 111, a storage device 113, and a communication device 115. Note, the hardware configuration indicated here is one example and some of the constituent elements may be omitted. Alternatively, the hardware configuration may further include other constituent elements than those indicated here.

### (CPU 101, ROM 103, and RAM 105)

The CPU 101 functions as an arithmetic processing device or a control device, for example, and controls all or part of the operations of various constituent elements on the basis of various programs recorded in the ROM 103, the RAM 105, or the storage device 113. The ROM 103 is a means of storing programs to be read into the CPU 101, and data or the like used for computation. The RAM 105 temporarily or permanently stores, for example, programs read into the CPU 101, and various parameters and the like that change accordingly when the programs are executed. These are mutually coupled via a host bus that includes a CPU bus or the like. The CPU 101, the ROM 103, and the RAM 105 may realize the functions of the controller 130 described with reference to FIG. 6 by cooperation with software, for example.

### (Input Device 107)

For the input device 107, for example, a touchscreen, a button, a switch, and the like are used. Further, a remote controller that is able to transmit control signals using infrared or other electromagnetic waves may also be used as the input device 107. The input device 107 also includes an audio input unit such as a microphone.

### (Display Device 109 and Audio Output Device 111)

The display device 109 includes display devices such as, for example, a CRT (Cathode Ray Tube) display device and a liquid crystal display (LCD) device. The display device 109 also includes display devices such as a projector device, an OLED (Organic Light Emitting Diode) device, and a lamp. Moreover, the audio output device 111 includes audio output devices such as a speaker or a headphone.

### (Storage Device 113)

The storage device 113 is a device for storing various sets of data. For the storage device 113, for example, magnetic memory devices such as a hard disk drive (HDD), a semiconductor memory device, an optical memory device, or a magneto-optical memory device, and the like are used. The storage device 113 may achieve the functions of the memory section 150, for example, described with reference to FIG. 6.

### (Communication Device 115)

The communication device 115 is a communication device for establishing a connection with a network such as, for example, a wired or wireless LAN, Bluetooth (Registered Trademark), a communication card for WUSB (Wireless USB), a router for optical communications, a router for ADSL (Asymmetric Digital Subscriber Line), and modems and the like for various communications.

A hardware configuration example of the mobile terminal according to the embodiment of the present disclosure has been described above with reference to FIG. 14.

### 4. CONCLUSION

As described above, the information processing apparatus according to the embodiment of the present disclosure calculates the status value of the moving body by the inertial navigation system on the basis of inertial data measured by the inertial measurement unit. Moreover, the information processing apparatus calculates the observation value of the moving body on the basis of the characteristic amount of movement calculated on the basis of the inertial data. Moreover, the information processing apparatus calculates the attitude information of the moving body on the basis of the status value and the observation value.

As described above, the information processing apparatus is able to calculate the status value, the observation value, and the attitude information by itself on the basis of the inertial data measured by the inertial measurement unit of its own. As a result, the information processing apparatus is able to correct the status value calculated by itself using the attitude information calculated by itself, to perform position estimation.

Accordingly, it is possible to provide an information processing apparatus, an information processing method, and a program that are novel and improved and allow for autonomous improvement of the accuracy of position estimation.

While a preferred embodiment of the present disclosure has been described above in detail with reference to the accompanying drawings, the technical scope of the present disclosure is not limited to these examples. It will be understood that any person of normal knowledge in the technical field of the present disclosure could obviously conceive various changes or modifications that can be made within the technical concept set forth in the claims and that these too will naturally belong to the technical scope of the present disclosure.

Moreover, the processes described herein with the use of a flowchart and a sequence diagram do not necessarily have to be executed in the illustrated order. Some of the process steps may be executed in parallel. Also, additional process steps may be adopted, and some of the process steps may be omitted.

The series of processes performed by various devices and units described herein may be realized by any of software, hardware, and a combination of software and hardware. Programs included in the software are preliminarily stored in respective internal units of the devices or recording media (non-transitory media) provided outside. Additionally, each program is read into the RAM when it is to be executed by a computer, for example, and executed by a processor such as a CPU.

It is also to be noted that the effects described herein are only illustrative or exemplary and not limiting. Namely, the technique according to the present disclosure may exhibit other effects in addition to the effects described above or in place of the effects described above, which are obvious to a person skilled in the art from the description herein.

Note, the following configurations also belong to the technical scope of the present disclosure.

(1)

An information processing apparatus including:

an inertial navigation computing unit that calculates, on a basis of a measurement value relating to a moving body measured by an inertial measurement unit, a status value relating to a moving status of the moving body by an inertial navigation system;

an observation value computing unit that calculates an observation value relating to the moving status of the moving body on a basis of a characteristic amount of movement relating to a movement of the moving body, the characteristic amount of movement being calculated on a basis of the measurement value; and

an attitude information computing unit that calculates attitude information relating to an attitude of the moving body on a basis of the status value and the observation value.

(2)

The information processing apparatus according to (1), in which

the attitude information computing unit feeds back the attitude information to the inertial navigation computing unit, and

the inertial navigation computing unit calculates the status value on a basis of the measurement value and the fed-back attitude information.

(3)

The information processing apparatus according to (2), in which the attitude information computing unit calculates a correction amount of the status value on a basis of a degree of divergence between a provisional status value and the observation value, the provisional status value being obtained by assigning a provisional error value to the status value calculated by the inertial navigation computing unit, and feeds back, as the attitude information, the correction amount to the inertial navigation computing unit.

(4)

The information processing apparatus according to (3), in which the attitude information computing unit calculates, while varying the provisional error value, the degree of divergence between each of a plurality of the provisional status values and the observation value corresponding to the each of the plurality of provisional status values, the plurality of provisional status values being calculated on a basis of a plurality of the measurement values measured within a predetermined period of time, and determines the provisional error value that minimizes the degree of divergence as the correction amount.

(5)

The information processing apparatus according to (4), in which the attitude information computing unit calculates a square of a difference between a first moving speed contained in the provisional status value and a second moving speed contained in the observation value corresponding to the provisional status value, the number of the calculated squares of the differences being identical to the number of the measurement values measured within the predetermined period of time, and determines a mean value of the plurality of calculated squares of the differences, as the degree of divergence.

(6)

The information processing apparatus according to (2), in which the attitude information computing unit calculates a corrected status value, the corrected status value being obtained by correcting the status value calculated by the inertial navigation computing unit on a basis of the observation value, and feeds back, as the attitude information, the corrected status value to the inertial navigation computing unit.

(7)

The information processing apparatus according to (6), in which the attitude information computing unit calculates the corrected status value on a basis of a difference between a third moving speed contained in the status value and a fourth moving speed of the moving body contained in the observation value.

(8)

The information processing apparatus according to any one of (1) to (7), in which the observation value computing unit uses, as the observation value, a value relating to a moving speed of the moving body.

(9)

The information processing apparatus according to (8), in which, in a case where the moving body is a walking moving body, the observation value computing unit uses, as the characteristic amount of movement, a stride frequency of the walking moving body calculated on a basis of the measurement value.

(10)

The information processing apparatus according to (9), in which the observation value computing unit uses, as the observation value, a moving speed of the walking moving body calculated on a basis of the stride frequency and a stride length of the walking moving body.

(11)

The information processing apparatus according to (9), in which, in a case where it is determined that the walking moving body is moving at a constant speed on a basis of the stride frequency, the observation value computing unit uses, as the observation value, a value indicating that an amount of change in speed is zero.

(12)

The information processing apparatus according to (9), in which, in a case where it is determined that the walking moving body is walking on a basis of the measurement value, the observation value computing unit uses, as the observation value, a value indicating that an amount of change in speed of the walking moving body is zero.

(13)

The information processing apparatus according to any one of (1) to (12), in which the status value includes a value indicating an attitude, a position, and a moving speed of the moving body.

(14)

An information processing method executed by a processor, the information processing method including:

calculating, on a basis of a measurement value relating to a moving body measured by an inertial measurement unit, a status value indicating a moving status of the moving body by an inertial navigation system;

calculating an observation value that is a correct value on a basis of a characteristic amount of movement relating to a movement of the moving body, the characteristic amount of movement being calculated on a basis of the measurement value; and

calculating attitude information relating to a correct attitude of the moving body on a basis of the status value and the observation value.

(15)

A program that causes a computer to function as:

an inertial navigation computing unit that calculates, on a basis of a measurement value relating to a moving body measured by an inertial measurement unit, a status value indicating a moving status of the moving body by an inertial navigation system;

an observation value computing unit that calculates an observation value that is a correct value on a basis of a characteristic amount of movement relating to a movement of the moving body, the characteristic amount of movement being calculated on a basis of the measurement value; and

an attitude information computing unit that calculates attitude information relating to a correct attitude of the moving body on a basis of the status value and the observation value.

### REFERENCE SIGNS LIST

10 mobile terminal
120 inertial measurement section
122 gyro sensor
124 accelerometer
130 controller
132 inertial navigation computing unit
134 observation value computing unit
136 attitude information computing unit
140 Communication Section
150 Memory Section

1. An information processing apparatus comprising:
an inertial navigation computing unit that calculates, on a basis of a measurement value relating to a moving body measured by an inertial measurement unit, a status value relating to a moving status of the moving body by an inertial navigation system;
an observation value computing unit that calculates an observation value relating to the moving status of the moving body on a basis of a characteristic amount of movement relating to a movement of the moving body, the characteristic amount of movement being calculated on a basis of the measurement value; and
an attitude information computing unit that calculates attitude information relating to an attitude of the moving body on a basis of the status value and the observation value.

2. The information processing apparatus according to claim 1, wherein
the attitude information computing unit feeds back the attitude information to the inertial navigation computing unit, and
the inertial navigation computing unit calculates the status value on a basis of the measurement value and the fed-back attitude information.

3. The information processing apparatus according to claim 2, wherein the attitude information computing unit calculates a correction amount of the status value on a basis of a degree of divergence between a provisional status value and the observation value, the provisional status value being obtained by assigning a provisional error value to the status value calculated by the inertial navigation computing unit, and feeds back, as the attitude information, the correction amount to the inertial navigation computing unit.

4. The information processing apparatus according to claim 3, wherein the attitude information computing unit calculates, while varying the provisional error value, the degree of divergence between each of a plurality of the provisional status values and the observation value corresponding to the each of the plurality of provisional status values, the plurality of provisional status values being calculated on a basis of a plurality of the measurement values measured within a predetermined period of time, and determines the provisional error value that minimizes the degree of divergence as the correction amount.

5. The information processing apparatus according to claim 4, wherein the attitude information computing unit calculates a square of a difference between a first moving speed contained in the provisional status value and a second moving speed contained in the observation value corresponding to the provisional status value, the number of the calculated squares of the differences being identical to the number of the measurement values measured within the predetermined period of time, and determines a mean value of the plurality of calculated squares of the differences, as the degree of divergence.

6. The information processing apparatus according to claim 2, wherein the attitude information computing unit calculates a corrected status value, the corrected status value being obtained by correcting the status value calculated by the inertial navigation computing unit on a basis of the observation value, and feeds back, as the attitude information, the corrected status value to the inertial navigation computing unit.

7. The information processing apparatus according to claim 6, wherein the attitude information computing unit calculates the corrected status value on a basis of a difference between a third moving speed contained in the status value and a fourth moving speed of the moving body contained in the observation value.

8. The information processing apparatus according to claim 1, wherein the observation value computing unit uses, as the observation value, a value relating to a moving speed of the moving body.

9. The information processing apparatus according to claim 8, wherein, in a case where the moving body is a walking moving body, the observation value computing unit uses, as the characteristic amount of movement, a stride frequency of the walking moving body calculated on a basis of the measurement value.

10. The information processing apparatus according to claim 9, wherein the observation value computing unit uses, as the observation value, a moving speed of the walking moving body calculated on a basis of the stride frequency and a stride length of the walking moving body.

11. The information processing apparatus according to claim 9, wherein, in a case where it is determined that the walking moving body is moving at a constant speed on a basis of the stride frequency, the observation value computing unit uses, as the observation value, a value indicating that an amount of change in speed is zero.

12. The information processing apparatus according to claim 9, wherein, in a case where it is determined that the walking moving body is walking on a basis of the measurement value, the observation value computing unit uses, as the observation value, a value indicating that an amount of change in speed of the walking moving body is zero.

13. The information processing apparatus according to claim 1, wherein the status value includes a value indicating an attitude, a position, and a moving speed of the moving body.

14. An information processing method executed by a processor, the information processing method comprising:
calculating, on a basis of a measurement value relating to a moving body measured by an inertial measurement unit, a status value indicating a moving status of the moving body by an inertial navigation system;
calculating an observation value that is a correct value on a basis of a characteristic amount of movement relating to a movement of the moving body, the characteristic amount of movement being calculated on a basis of the measurement value; and
calculating attitude information relating to a correct attitude of the moving body on a basis of the status value and the observation value.

15. A program that causes a computer to function as:
an inertial navigation computing unit that calculates, on a basis of a measurement value relating to a moving body measured by an inertial measurement unit, a status value indicating a moving status of the moving body by an inertial navigation system;
an observation value computing unit that calculates an observation value that is a correct value on a basis of a characteristic amount of movement relating to a movement of the moving body, the characteristic amount of movement being calculated on a basis of the measurement value; and
an attitude information computing unit that calculates attitude information relating to a correct attitude of the moving body on a basis of the status value and the observation value.
